(19) United States
(12) Patent Application Publication
(10) Pub. No.: US 2026/0168843 A1
(43) Pub. Date: Jun. 18, 2026

(54) METHOD AND DEVICE FOR MONITORING CARGO WEIGHT

(71) Applicants: HYUNDAI MOTOR COMPANY, Seoul (KR); KIA CORPORATION, Seoul (KR)

(72) Inventors: Minju Kim, Hwaseong-si (KR); Sae Yong Jang, Hwaseong-si (KR)

(73) Assignees: HYUNDAI MOTOR COMPANY, Seoul (KR); KIA CORPORATION, Seoul (KR)

(21) Appl. No.: 19/395,965

(22) Filed: Nov. 20, 2025

(30) Foreign Application Priority Data
Dec. 12, 2024 (KR) 10-2024-0184518

(51) Int. Cl. G01G 19/08; B60Q 9/00; G01C 21/34; G01G 23/18; G07C 5/02

(52) U.S. Cl. CPC G01G 19/08; B60Q 9/00; G01C 21/3469; G01G 23/18; G07C 5/02

(57) ABSTRACT

A method for monitoring cargo weights includes: receiving first remote data on whether to activate cargo weight monitoring from a remote server; determining whether a value of the first remote data indicates an activation of cargo weight monitoring; based on the value of the first remote data indicating the activation of cargo weight monitoring, receiving second remote data on a reference weight value for determining whether to warn an overload from the remote server; receiving first local data on a body weight of the vehicle and second local data on a cargo bay weight of the vehicle; determining a total weight of the vehicle by using the first local data and the second local data; comparing the total weight and the second remote data; and based on the total weight being greater than the second remote data, determining that the vehicle is overloaded.

### CROSS-REFERENCE TO RELATED APPLICATION

This application claims priority to and the benefit of Korean Patent Application No. 10-2024-0184518 filed with the Korean Intellectual Property Office on Dec. 12, 2024, the entire contents of which are incorporated herein by reference.

### TECHNICAL FIELD

The present disclosure relates to a method and a device for monitoring cargo weights and more particularly relates to a method and a device for monitoring cargo weights for controlling driving of a vehicle when a load weight is exceeded.

### BACKGROUND

According to the Road Traffic Act, the loaded weight of a truck is limited to 110% of the loaded weight according to the vehicle's structure and performance. However, it is difficult to accurately measure the weight during the loading process, so the loading weight regulations are often overlooked. This may lead to serious damage, such as objects falling or damage to objects, and driving with excess loads may place excessive strain on various vehicle systems, such as tires and engine. Therefore, strict adherence to the specified load weight is very important for safety and vehicle protection. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure attempts to provide a method and a device for monitoring cargo weights for preventing falling object accidents and vehicle failures by measuring the weight of the cargo bay and generating a warning and blocking the driving system when the weight exceeds a reference value.

According to an embodiment of the present disclosure, a method for monitoring cargo weights includes receiving, by a processor of a vehicle, first remote data on whether to activate cargo weight monitoring from a remote server through a communication interface of the vehicle. The method further includes determining, by the processor, whether a value of the first remote data indicates an activation of cargo weight monitoring. The method further includes, based on the value of the first remote data indicating the activation of cargo weight monitoring, receiving, by the processor, second remote data on a reference weight value for determining whether to warn of an overload from the remote server through the communication interface. The method further includes receiving, by the processor, first local data on a body weight of the vehicle and second local data on a cargo bay weight of the vehicle through an internal network of the vehicle. The method further includes calculating or determining, by the processor, a total weight of the vehicle by using the first local data and the second local data. The method further includes comparing, by the processor, the total weight and the second remote data. The method further includes, based on the total weight being greater than the second remote data, determining, by the processor, that the vehicle is overloaded.

In some embodiments, the method may further include, based on the total weight being greater than the second remote data, setting, by the processor, a flag on an overload weight state as a first value during a loading or an unloading of the vehicle. The method may further include, based on the total weight being not greater than the second remote data, setting the flag as a second value different from the first value during the loading or the unloading of the vehicle. The method may further include transmitting, by the processor, the flag to the remote server through the communication interface. The method may further include generating, by the processor, an overload warning notice through at least one of a buzzer mounted on a cargo bay of the vehicle and a dashboard of the vehicle.

In some embodiments, the method may further include checking, by the processor, a type of the vehicle. The method may further include, based on the type of the vehicle being an open cargo type by which loaded goods are transported while exposed to an outside, determining, by the processor, whether a first condition that a starting of the vehicle is turned off is satisfied or a second condition that a gear of the vehicle is P-stage and a speed of the vehicle is equal to or less than a predetermined reference speed is satisfied. The method may further include, based on the first condition or the second condition being satisfied, determining, by the processor, that the vehicle is being loaded or unloaded.

In some embodiments, the method may further include checking, by the processor, a type of the vehicle. The method may further include, based on the type of the vehicle being an enclosed cargo type by which loaded goods are transported in a closed and sealed space, determining, by the processor, whether a first condition that a starting of the vehicle is turned off is satisfied or a second condition that a gear of the vehicle is P-stage, a speed of the vehicle is equal to or less than a predetermined reference speed, and at least one door of the vehicle is opened is satisfied. The method may further include, based on the first condition or the second condition being satisfied, determining, by the processor, that the vehicle is being loaded or unloaded.

In some embodiments, the method may further include during a driving of the vehicle, receiving, by the processor, the flag from the remote server; and based on a value of the flag being the first value, performing, by the processor, a stop inducing operation.

In some embodiments, the method may further include checking, by the processor, a type of the vehicle. The method may further include, based on the type of the vehicle being an open cargo type by which loaded goods are transported while exposed to an outside, determining, by the processor, whether a first condition that a starting of the vehicle is turned on is satisfied or a second condition that a gear of the vehicle is not P-stage and a speed of the vehicle is greater than a predetermined reference speed is satisfied. The method may further include, based on the first condition or the second condition being satisfied, determining, by the processor, that the vehicle is driving (or being driven).

In some embodiments, the method may further include checking, by the processor, a type of the vehicle. The method may further include, based on the type of the vehicle being an enclosed cargo type by which loaded goods are transported in a closed and sealed space, determining, by the processor, whether a first condition that a starting of the vehicle is turned on is satisfied or a second condition that a gear of the vehicle is not P-stage, a speed of the vehicle is greater than a predetermined reference speed, and doors of the vehicle are closed is satisfied. The method may further include, based on the first condition or the second condition being satisfied, determining, by the processor, that the vehicle is driving (or being driven).

In some embodiments, based on a value of the first remote data failing to indicate the activation of cargo weight monitoring, of the method may include activating cargo weight monitoring and determining the reference weight value according to a user input through an audio video navigation (AVN) system.

In some embodiments, the method may further include, based on the total weight being not greater than the second remote data, transmitting, by the processor, the total weight to a navigation device installed in the vehicle, and allowing the navigation device to generate a recommended path bypassing a weight restricted road exceeding the total weight.

In some embodiments, the method may further include obtaining, by the processor, a residual of a battery or fuel of the vehicle from an integrated vehicle controller. The method may further include, based on the residual being less than a predetermined first ratio compared to an entire amount, notifying, by the processor, a display device in the vehicle that the reference weight value is about to be changed. The method may further include allowing, by the processor, a navigation device mounted on the vehicle to generate a recommended path bypassing a gas station.

In some embodiments, notifying the display device in the vehicle may include, based on the residual being less than a second ratio that is predetermined to be less than the predetermined first ratio compared to the entire amount, changing, by the processor, the reference weight value to a lower value and notifying the change of the reference weight value to the display device.

In some embodiments, the first local data may include a value calculated by multiplying basic weights for respective predetermined vehicle types by a predetermined weight.

According to another embodiment of the present disclosure, a device for monitoring cargo weights implemented in a vehicle includes a communication interface; at least one non-transitory computer-readable medium configured to store instructions; and at least one processor configured, by executing the instructions, to receive first remote data on whether to activate cargo weight monitoring from a remote server through the communication interface. The at least one processor is further configured to determine whether a value of the first remote data indicates an activation of cargo weight monitoring. The at least one processor is further configured, based on the value of the first remote data indicating the activation of cargo weight monitoring, to receive second remote data on a reference weight value for determining whether to warn an overload from the remote server through the communication interface. The at least one processor is further configured to receive first local data on a body weight of the vehicle and second local data on a cargo bay weight of the vehicle through an internal network of the vehicle. The at least one processor is further configured to calculate or determine a total weight of the vehicle by using the first local data and the second local data. The at least one processor is further configured to compare the total weight and the second remote data. The at least one processor is further configured, based on the total weight being greater than the second remote data, to determine that the vehicle is overloaded.

In some embodiments, the at least one processor may further be configured to, based on the total weight being greater than the second remote data, set a flag on an overload weight state to be a first value during loading or unloading of the vehicle. The at least one processor may further be configured to, based on the total weight being not greater than the second remote data, set the flag to be a second value that is different from the first value during the loading or the unloading of the vehicle. The at least one processor may further be configured to transmit the flag to the remote server through the communication interface. The at least one processor may further be configured to generate an overload warning notice through at least one of a buzzer installed in a cargo bay of the vehicle and a dashboard of the vehicle.

In some embodiments, the at least one processor may further be configured to, during a driving of the vehicle, receive the flag from the remote server, and based on a value of the flag being the first value, perform a stop inducing operation.

In some embodiments, the at least one processor may further be configured to, based on the total weight being not greater than the second remote data, transmit the total weight to a navigation device installed in the vehicle and allow the navigation device to generate a recommended path bypassing a weight restricted road exceeding the total weight.

In some embodiments, the at least one processor may further be configured to obtain a residual of a battery or fuel of the vehicle from an integrated vehicle controller. The at least one processor may further be configured to, based on the residual being less than a predetermined first ratio compared to an entire amount, notify a display device in the vehicle that the reference weight value is about to be changed. The at least one processor may further be configured to allow a navigation device mounted on the vehicle to generate a recommended path bypassing a gas station.

In some embodiments, the at least one processor may further be configured to, based on the residual being less than a second ratio that is predetermined to be less than the predetermined first ratio compared to the entire amount, change the reference weight value to a lower value and notify the change of the reference weight value to the display device.

In some embodiments, the first local data may include a value calculated by multiplying basic weights for respective predetermined vehicle types by a predetermined weight.

Another embodiment of the present disclosure provides a non-transitory computer-readable medium configured to store instructions executable by a computing device. When executed by at least one processor of the computing device, the instructions allow the computing device to receive first remote data on whether to activate cargo weight monitoring from a remote server through a communication interface. The instructions further allow the computing device to determine whether a value of the first remote data indicates the activation of cargo weight monitoring. The instructions further allow the computing device, based on the value of the first remote data indicating the activation of cargo weight monitoring, to receive second remote data on a reference weight value for determining whether to warn an overload from the remote server through the communication interface. The instructions further allow the computing device to receive first local data on a body weight of a vehicle and second local data on a cargo bay weight of the vehicle through an internal network of the vehicle. The instructions further allow the computing device to calculate a total weight of the vehicle by using the first local data and the second local data. The instructions further allow the computing device to compare the total weight and the second remote data. The instructions further allow the computing device, based on the total weight being greater than the second remote data, to determine that the vehicle is overloaded.

### BRIEF DESCRIPTION OF THE DRAWINGS

FIG. 1 shows a device for monitoring cargo weights according to an embodiment.

FIG. 2 shows an example of a device and a method for monitoring cargo weights according to an embodiment.

FIG. 3 shows an example of a device and a method for monitoring cargo weights according to an embodiment.

FIG. 4 shows a method for monitoring cargo weights according to an embodiment.

FIG. 5 shows a computing device according to an embodiment.

### DETAILED DESCRIPTION

The present disclosure is described more fully hereinafter with reference to the accompanying drawings, in which embodiments of the present disclosure are shown. As those having ordinary skill in the art should realize, the described embodiments may be modified in various different ways, all without departing from the spirit or scope of the present disclosure. Accordingly, the drawings and description should be regarded as illustrative in nature and not restrictive, and like reference numerals designate like elements throughout the present disclosure.

Unless explicitly described to the contrary, the word “comprise” and its variations such as “comprises” or “comprising” are intended to include stated elements instead of excluding any other elements. Terms including ordinal numbers such as first, second, and the like are used only to describe various components and should not be interpreted as limiting these components. The terms are only used to differentiate one component from other components.

The terms such as “ . . . part,” “ . . . portion,” “ . . . er/or,” or “module” disclosed in the present disclosure may mean a unit that may process at least one function or operation described in the present disclosure, and this may be implemented by hardware, software, or a combination thereof. At least some components or functions in the method and device for monitoring cargo weights according to embodiments may be implemented as a program or software, and the program or software may be stored in a computer-readable medium. When a controller, “ . . . part,” “ . . . portion,” “ . . . er/or,” module, component, device, element, or the like of the present disclosure is described as having a purpose or performing an operation, function, or the like, the controller, “ . . . part,” “ . . . portion,” “ . . . er/or,” module, component, device, element, or the like should be considered herein as being “configured to” meet that purpose or to perform that operation or function. Each controller, “ . . . part,” “ . . . portion,” “ . . . er/or,” module, component, device, element, and the like may separately embody or be included with a processor and a memory, such as a non-transitory computer readable media, as part of the apparatus.

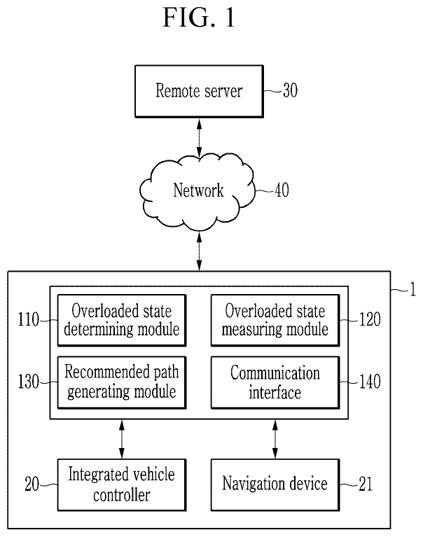

FIG. 1 shows a device for monitoring cargo weights according to an embodiment.

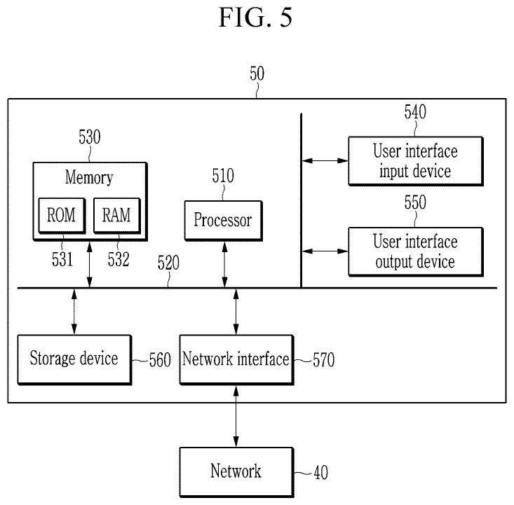

Referring to FIG. 1, the device for monitoring cargo weights 10 may be implemented as a computing device including a processor and a memory. For example, the device for monitoring cargo weights 10 may be implemented as a computing device 50 to be described below with reference to FIG. 5. The computing device 50 may be implemented as a device realized in the vehicle 1, for example, as a controller mounted on the vehicle 1. In this case, the processor may correspond to a processor 510 of the computing device 50, and the memory may correspond to a memory 520 of the computing device 50. In some embodiments, the device for monitoring cargo weights 10 may include at least one non-transitory computer-readable medium including instructions and at least one processor for performing operations by executing instructions. The operations may include configurations, functions, stages, etc. described in the present specification on the method and device for monitoring cargo weights according to embodiments. In the present disclosure, the term “module” is used to logically separate these operations performed by the method and device for monitoring cargo weights according to embodiments.

The device for monitoring cargo weights 10 may be implemented in the vehicle 1. The device for monitoring cargo weights 10 may exchange data with an integrated vehicle controller 20 implemented in the vehicle 1 through an internal network. In some embodiments, the internal network may include a controller area network (CAN), a local interconnect network (LIN), and an automotive Ethernet. The integrated vehicle controller 20 may comprehensively manage and control various systems mounted in the vehicle 1.

The device for monitoring cargo weights 10 may exchange data with a remote server 30 through the network 40. The remote server 30 may represent a server owned or serviced by a transportation provider. For example, the vehicle 1 is a goods delivery vehicle that may communicate with the remote server 30 and may receive various types of information, including goods delivery paths, goods delivery schedules, and goods delivery stages. The vehicle 1 may also provide various types of information on the status of the goods delivery and the status of the vehicle 1 to the remote server 30. The network 40 may include a wireless network, which may be implemented as, for example, a cellular network, a WiFi network, etc.

The device for monitoring cargo weights 10 may include an overloaded state determining module 110, an overloaded state measuring module 120, a recommended path generating module 130 and a communication interface 140.

The overloaded state determining module 110 may receive remote data from the remote server 30 through the communication interface 140. The remote data may include first remote data and second remote data.

The first remote data may relate to whether to activate monitoring of cargo weights, and the first remote data may include a value indicating activation of cargo weight monitoring or a value indicating deactivation of cargo weight monitoring. The values may be implemented as, for example, Boolean-type values, integer-type values, real number-type values, enumerated-type values, string values, bit flag values, etc. The second remote data may include a reference weight value determining whether to warn an overload. The second remote data may be received from the remote server 30 when the value of the first remote data is determined to indicate activation of cargo weight monitoring.

The overloaded state determining module 110 may receive first local data and second local data from the integrated vehicle controller 20 through the internal network of the vehicle 1. The first local data may include a body weight of the vehicle 1, and the second local data may include a cargo bay weight of the vehicle 1.

In some embodiments, the first local data may include values that are products of predetermined weights (e.g., 1.2) and predetermined basic weights for respective vehicle types.

The overloaded state determining module 110 may determine whether the value of the first remote data indicates activation of cargo weight monitoring. When the value of the first remote data is determined to indicate activation of cargo weight monitoring, the overloaded state determining module 110 may receive second remote data on the reference weight value for determining whether to warn an overload from the remote server 30 through the communication interface 140.

The overloaded state determining module 110 may calculate the total weight of the vehicle 1 by using first local data corresponding to the body weight and the second local data corresponding to the cargo bay weight. In detail, the overloaded state determining module 110 may calculate the total weight by summing the first local data and the second local data.

The overloaded state determining module 110 may compare the total weight with the second remote data corresponding to the reference weight value for determining whether to warn of an overload. When the total weight is greater than the second remote data, the overloaded state determining module 110 may determine that the vehicle 1 is overloaded.

In some embodiments, when the vehicle is loading or unloading (i.e., being loaded or unloaded) and the total weight is greater than the second remote data, the overloaded state measuring module 120 may set a flag on the overload weight state as a first value (e.g., a value indicating true) and may transmit the flag to the remote server 30 through the communication interface 140. The overloaded state measuring module 120 may generate an overload warning notice through at least one of a buzzer mounted in the cargo bay of the vehicle 1 and a dashboard of the vehicle 1. When the vehicle is being loaded or unloaded and the total weight is not greater than the second remote data, the overloaded state measuring module 120 may set the flag as a second value that is different from the first value (e.g., a value indicating false).

In some embodiments, the overloaded state measuring module 120 may check the type of the vehicle 1. When it is determined that the type of the vehicle 1 is an open cargo type, the overloaded state measuring module 120 may determine whether the first condition that the starting of the vehicle 1 is turned off is satisfied, or the second condition that the gear of the vehicle 1 is P-stage and the speed of the vehicle 1 is equal to or less than a predetermined reference speed (e.g., 3 km/h) is satisfied. The open cargo may represent a cargo transported with loaded goods exposed to the outside. When the first condition or the second condition is determined to be satisfied, the overloaded state measuring module 120 may determine that the vehicle 1 is being loaded or unloaded.

In some embodiments, the overloaded state measuring module 120 may check the type of the vehicle 1. When it is checked that the type of the vehicle 1 is an enclosed cargo type, the overloaded state measuring module 120 may determine whether a first condition that the starting of the vehicle 1 is turned off is satisfied, or a second condition that the gear of the vehicle 1 is P-stage, the speed of the vehicle 1 is less than or equal to a predetermined reference speed (e.g., 3 km/h), and at least one door of the vehicle 1 is opened is satisfied. The enclosed cargo may represent a cargo in which loaded goods are transported in a closed and sealed space. When the first condition or the second condition is determined to be satisfied, the overloaded state measuring module 120 may determine that the vehicle 1 is being loaded or unloaded.

In some embodiments, when the vehicle is driving or being driven, the overloaded state measuring module 120 may receive a flag from the remote server 30. When the value of the flag is the first value, the overloaded state measuring module 120 may execute a stop inducing operation. The stop inducing operation may be, for example, set to a timer for a predetermined time (e.g., 3 minutes), and a warning notice may be displayed through a cluster, a navigation device, etc., of the vehicle 1. The warning notice may be implemented as, for example, “Cargo weight exceeds the reference value”, “Emergency braking operation will be performed if the vehicle is not stopped within 3 minutes”. The warning notice may be lifted if the vehicle 1 is detected to be stationary within a predetermined time. Whether the vehicle 1 stops may be determined based on, for example, whether the gear is P-stage and the speed is equal to or less than a predetermined speed (e.g., 3 km/h). When the vehicle 1 is not detected to be stationary within a predetermined time, emergency braking may be performed with an additional warning notice. The additional warning notices may be implemented as, for example, “The emergency braking function will start activating because the cargo is overweight.”

The emergency braking may be implemented as a method for transmitting an activation signal of the corresponding function to the emergency braking system implemented in advance in the vehicle 1. The stop inducing operation is not limited to the implementation described here and may be implemented in other ways as well.

In some embodiments, the overloaded state measuring module 120 may check the type of the vehicle 1. When it is checked that the type of vehicle 1 is an open cargo type, the overloaded state measuring module 120 may determine whether a first condition that the starting of the vehicle 1 is turned on is satisfied, or a second condition that the gear of the vehicle 1 is not P-stage and the speed of the vehicle 1 is greater than a predetermined reference speed (e.g., 3 km/h) is satisfied. When the first condition or the second condition is determined to be satisfied, the overloaded state measuring module 120 may determine that the vehicle 1 is driving or being driven.

In some embodiments, the overloaded state measuring module 120 may check the type of the vehicle 1. When it is checked that the type of the vehicle 1 is an enclosed cargo type, the overloaded state measuring module 120 may determine whether a first condition is satisfied that the starting of the vehicle 1 is turned on, or a second condition is satisfied that the gear of the vehicle 1 is not P-stage, the speed of the vehicle 1 is greater than a predetermined reference speed (e.g., 3 km/h), and all doors of the vehicle 1 are closed. When the first condition or the second condition is determined to be satisfied, the overloaded state measuring module 120 may determine that the vehicle 1 is driving or being driven.

When the overloaded state determining module 110 determines whether the value of the first remote data indicates the activation of cargo weight monitoring and determines that the value of the first remote data does not indicate the activation of cargo weight monitoring, the activation of cargo weight monitoring and the reference weight value may be determined based on a user's input through an audio video navigation (AVN) system (e.g., navigation device 21).

The recommended path generating module 130 may transmit the total weight to the navigation device 21 mounted on the vehicle 1 when the total weight is not greater than the second remote data, thereby causing the navigation device 21 to generate a recommended path that avoids a weight restricted road that exceeds the total weight.

In some embodiments, the recommended path generating module 130 may obtain a residual of a battery or fuel of the vehicle 1 from the integrated vehicle controller 20. When the residual is less than a predetermined first ratio (e.g., 25%) of the entire amount, the recommended path generating module 130 may notify a display device in the vehicle 1 that the reference weight value is about to be changed. The recommended path generating module 130 may allow the navigation device 21 mounted on the vehicle 1 to generate a recommended path bypassing a gas station.

In some embodiments, the recommended path generating module 130 may change the reference weight value to a lower value when the residual is less than a predetermined second ratio (e.g., 15%) set to be less than the first ratio compared to the entire amount and may notify the display device in the vehicle 1 that the reference weight value has been changed.

According to the present embodiment, it is possible to prevent loss costs caused by violation of the loading weight, and it is possible to prevent damage to vehicle parts and accidents during driving due to overloading. In detail, it may prevent tire failure due to overloading, excessive wear and explosion, damage to parts due to engine overheating, rapid wear and damage due to load on the suspension and brake system. It may reduce the risk of accidents caused by cargo falling on highways and sharp curves, or accidents caused by sudden braking or on downhill slopes due to long braking distances of a heavy vehicle.

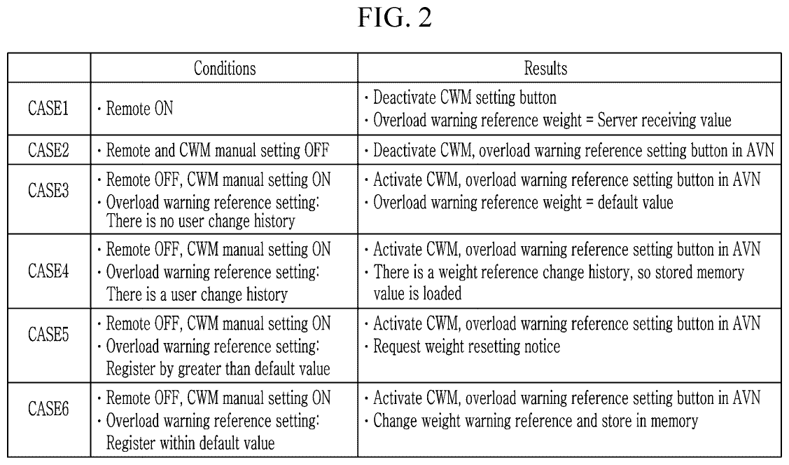

FIG. 2 shows an example of a device and method for monitoring cargo weights according to an embodiment.

Referring to FIG. 2, in the first case, when the value of the first remote data is determined to indicate activation of cargo weight monitoring (“remote ON”), a setting button (“CWM setting button”) of the cargo weight monitoring function is deactivated, and the reference weight value for determining whether to warn an overload may be set to the value of the second remote data received from the remote server 30.

In the second case, when the value of the first remote data is determined to indicate deactivation of cargo weight monitoring, and a manual setting of the cargo weight monitoring function through the AVN system is deactivated, a button for setting the cargo weight monitoring function in the AVN and the reference for determining whether to warn an overload may be deactivated.

In the third case, when the value of the first remote data is determined to indicate deactivation of cargo weight monitoring, the manual setting of the cargo weight monitoring function through the AVN system is activated, and there is no user change history for the reference setting for determining whether to warn an overload, the button for setting the cargo weight monitoring function in the AVN and the reference for determining whether to warn an overload may be activated, and the reference weight value for determining whether to warn an overload may be set as a default value.

In the fourth case, when the value of the first remote data is determined to indicate deactivation of cargo weight monitoring, and the manual setting of the cargo weight monitoring function through the AVN system is activated, there is a user change history for the reference setting for determining whether to warn an overload, the button for setting the cargo weight monitoring function in the AVN and the reference for determining whether to warn an overload may be activated, and the memory value stored according to the change history may be set as the reference weight value for determining whether to warn an overload.

In the fifth case, when the value of the first remote data is determined to indicate deactivation of cargo weight monitoring, the manual setting of the cargo weight monitoring function through the AVN system is activated, and the reference setting for determining whether to warn an overload is registered to be greater than the default value, the button for setting the cargo weight monitoring function in the AVN and the reference for determining whether to warn an overload may be activated, and a request of a notice for resetting the reference weight value for determining whether to warn an overload may be generated.

In the sixth case, when the value of the first remote data is determined to indicate deactivation of cargo weight monitoring, the manual setting of the cargo weight monitoring function through the AVN system is activated, and the reference setting for determining whether to warn an overload is registered without exceeding the default value, the button for setting the cargo weight monitoring function in the AVN and the reference that determines whether to warn an overload are activated, and the reference for determining whether to warn an overload may be changed and may be stored in the memory.

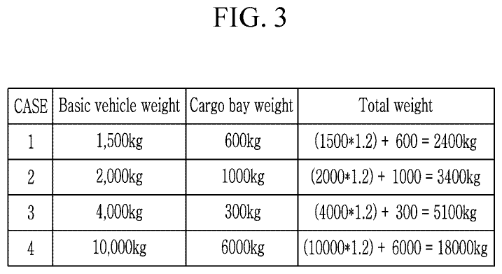

FIG. 3 shows an example of a device and method for monitoring cargo weights according to an embodiment.

Referring to FIG. 3, the overloaded state determining module 110 may calculate the total weight of the vehicle 1 using the first local data corresponding to the body weight and the second local data corresponding to the cargo bay weight, where the first local data may include a value calculated by multiplying a basic weight of a predetermined vehicle type by a predetermined weight (e.g., 1.2).

For example, in the first case, when the vehicle basic weight corresponding to the first local data is 1,500 kg and the cargo bay weight corresponding to the second local data is 600 kg, the total weight may be calculated as (1,500*1.2)+600=2,400 kg. In the second case, when the vehicle basic weight corresponding to the first local data is 2,000 kg and the cargo bay weight corresponding to the second local data is 1,000 kg, the total weight may be calculated as (2,000*1.2)+1,000=3,400 kg.

In the third case, when the vehicle basic weight corresponding to the first local data is 4,000 kg and the cargo bay weight corresponding to the second local data is 300 kg, the total weight may be calculated as (4,000*1.2)+300=5,100 kg. In the fourth case, when the vehicle basic weight corresponding to the first local data is 10,000 kg and the cargo bay weight corresponding to the second local data is 6,000 kg, the total weight may be calculated as (10,000*1.2)+6,000=18,000 kg.

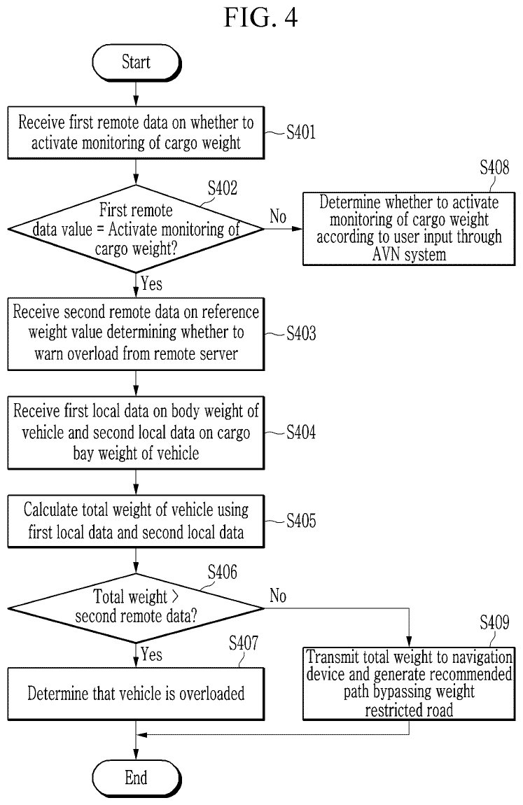

FIG. 4 shows a method for monitoring cargo weights according to an embodiment.

Referring to FIG. 4, the method for monitoring cargo weights according to an embodiment may include: receiving first remote data on activation of cargo weight monitoring from a remote server (S401); and determining whether a value of the first remote data indicates activation of cargo weight monitoring (S402).

When the value of the first remote data is determined to indicate activation of cargo weight monitoring (S402, ‘Yes’), the method may include: receiving second remote data on a reference weight value for determining whether to warn an overload from a remote server (S403); receiving first local data on a body weight of the vehicle and second local data on a cargo bay weight of the vehicle (S404); calculating or determining the total weight of the vehicle using the first local data and the second local data (S405); and comparing the total weight with the second remote data (S406).

When the total weight is greater than the second remote data (S406, ‘Yes’), the method may include determining that the vehicle is overloaded (S407). When the total weight is not greater than the second remote data (S406, ‘No’), the method may include transmitting the total weight to the navigation device and generating a recommended path bypassing the weight restricted road (S409).

When the value of the first remote data is determined not to indicate activation of cargo weight monitoring (S402, ‘No’), the method may include determining whether to activate cargo weight monitoring based on user input through the AVN system (S408).

More detailed information on the method for monitoring cargo weights may refer to the description of another embodiment included in the present specification, so redundant descriptions are omitted here.

FIG. 5 shows a computing device according to an embodiment.

Referring to FIG. 5, the method and device for monitoring cargo weights according to embodiments may be implemented using a computing device 50. The computing device 50 may be implemented as various types of electronic devices, servers or similar devices, and their functions may be implemented through a combination of software and hardware.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive signals to/from other entities through the network 40.

The processor 510 may be implemented with various types of operation devices, such as a micro controller unit (MCU), an application processor (AP), a central processing unit (CPU), a graphic processing unit (GPU), a neural processing unit (NPU), and a quantum processing unit (QPU). The processor 510 is a semiconductor device for executing instructions stored in the memory 530 or the storage device 560 and may perform a core function of the system. Program codes and data stored in the memory 530 or the storage device 560 may instruct the processor 510 to perform specific tasks, thereby enabling system-wide operations. The processor 510 may be configured to implement various functions and methods described above with reference to FIG. 1-FIG. 4.

The memory 530 and the storage device 560 may include various forms of volatile or non-volatile storage media for storing and accessing data by the system. For example, the memory 530 may include a read-only memory (ROM) 531 and a random access memory (RAM) 532. In some embodiments, the memory 530 may be installed in the processor 510, and in this case, the data transmission rate between the memory 530 and the processor 510 may be very fast. In some embodiments, the memory 530 may be disposed outside the processor 510, and the memory 530 may be connected to the processor 510 through various data buses or interfaces. This connection may be made through a variety of known means, for example, the peripheral component interconnect express (PCIe) interface for high-rate data transmission or through a memory controller.

In some embodiments, at least some components or functions of the method and device for monitoring cargo weights according to the embodiments may be implemented as a program or software executed on the computing device 50, and the program or software may be stored on a computer-readable recording medium or storage medium. In detail, the computer-readable recording medium or storage medium according to an embodiment may record a program for causing a computer including a processor 510 for executing the program or instructions stored in the memory 530 or the storage device 560 to execute stages included in implementing the method and device for monitoring cargo weights according to embodiments.

In some embodiments, at least some components or functions of the method and device for monitoring cargo weights according to embodiments may be implemented using hardware or circuitry of the computing device 50 or may be implemented as separate hardware or circuitry electrically connected to the computing device 50.

In some embodiments, at least one non-transitory computer readable medium including instruction executable by the computing device 50 may be provided, and the instructions may allow the computing device 50 to perform operations when executed by at least one processor of the computing device 50. Here, the operations may include the configurations, functions, stages, etc. described in the present specification on the method and device for monitoring cargo weights according to embodiments.

According to the embodiments, the present disclosure may prevent loss costs caused by violation of loading weights and may prevent damage to vehicle parts and accidents during driving due to overloading. In detail, it may prevent tire failure due to overloading, excessive wear and explosion, damage to parts due to engine overheating, rapid wear and damage due to load on the suspension and brake system. The present disclosure may reduce the risk of accidents caused by cargo falling on the highways and sharp curves, or accidents caused by sudden braking or on downhill slopes due to long braking distances of a heavy vehicle.

While the embodiments of the present disclosure have been described in detail, it should be understood that the present disclosure is not limited to the disclosed embodiments but is intended to cover various modifications and equivalent arrangements included within the spirit and scope of the appended claims.

What is claimed is:

1. A method for monitoring cargo weights, the method comprising:
receiving, by a processor of a vehicle, first remote data on whether to activate cargo weight monitoring from a remote server through a communication interface of the vehicle;
determining, by the processor, whether a value of the first remote data indicates an activation of cargo weight monitoring;
based on the value of the first remote data indicating the activation of cargo weight monitoring, receiving, by the processor, second remote data on a reference weight value for determining whether to warn an overload from the remote server through the communication interface;
receiving, by the processor, first local data on a body weight of the vehicle and second local data on a cargo bay weight of the vehicle through an internal network of the vehicle;
determining, by the processor, a total weight of the vehicle by using the first local data and the second local data;
comparing, by the processor, the total weight and the second remote data; and
based on the total weight being greater than the second remote data, determining, by the processor, that the vehicle is overloaded.

2. The method of claim 1, further comprising:
based on the total weight being greater than the second remote data, setting, by the processor, a flag on an overload weight state as a first value during a loading or an unloading of the vehicle;
based on the total weight not being greater than the second remote data, setting, by the processor, the flag as a second value different from the first value during the loading or the unloading of the vehicle;
transmitting, by the processor, the flag to the remote server through the communication interface; and
generating, by the processor, an overload warning notice through at least one of a buzzer mounted on a cargo bay of the vehicle and a dashboard of the vehicle.

3. The method of claim 2, further comprising
checking, by the processor, a type of the vehicle;
based on the type of the vehicle being an open cargo type by which loaded goods are transported while exposed to an outside, determining, by the processor, whether a first condition that a starting of the vehicle is turned off is satisfied or a second condition that a gear of the vehicle is P-stage and a speed of the vehicle is equal to or less than a predetermined reference speed is satisfied; and
based on the first condition or the second condition being determined to be satisfied, determining, by the processor, that the vehicle is being loaded or unloaded.

4. The method of claim 2, further comprising:
checking, by the processor, a type of the vehicle;
based on the type of the vehicle being an enclosed cargo type by which loaded goods are transported in a closed and sealed space, determining, by the processor, whether a first condition that a starting of the vehicle is turned off is satisfied or a second condition that a gear of the vehicle is P-stage, a speed of the vehicle is equal to or less than a predetermined reference speed, and at least one door of the vehicle is opened is satisfied; and
based on the first condition or the second condition is satisfied, determining, by the processor, that the vehicle is being loaded or unloaded.

5. The method of claim 2, further comprising:
during a driving operation of the vehicle, receiving, by the processor, the flag from the remote server; and
based on a value of the flag being the first value, performing, by the processor, a stop inducing operation.

6. The method of claim 5, further comprising:
checking, by the processor, a type of the vehicle;
based on the type of the vehicle being an open cargo type by which loaded goods are transported while exposed to an outside, determining, by the processor, whether a first condition that a starting of the vehicle is turned on is satisfied or a second condition that a gear of the vehicle is not P-stage and a speed of the vehicle is greater than a predetermined reference speed is satisfied; and
based on the first condition or the second condition being satisfied, determining, by the processor, that the vehicle is driving.

7. The method of claim 5, further comprising:
checking, by the processor, a type of the vehicle;
based on the type of the vehicle being an enclosed cargo type by which loaded goods are transported in a closed and sealed space, determining, by the processor, whether a first condition that a starting of the vehicle is turned on is satisfied or a second condition that a gear of the vehicle is not P-stage, a speed of the vehicle is greater than a predetermined reference speed, and doors of the vehicle are closed is satisfied; and
based on the first condition or the second condition being satisfied, determining, by the processor, that the vehicle is driving.

8. The method of claim 1, further comprising:
based on a value of the first remote data failing to indicate the activation of cargo weight monitoring, activating cargo weight monitoring and determining the reference weight value according to a user input through an audio video navigation (AVN) system.

9. The method of claim 1, further comprising:
based on the total weight being not greater than the second remote data, transmitting, by the processor, the total weight to a navigation device installed in the vehicle and allowing the navigation device to generate a recommended path bypassing a weight restricted road exceeding the total weight.

10. The method of claim 1, further comprising:
obtaining, by the processor, a residual of a battery or fuel of the vehicle from an integrated vehicle controller;
based on the residual being less than a predetermined first ratio compared to an entire amount, notifying, by the processor, a display device in the vehicle that the reference weight value is about to be changed; and
allowing, by the processor, a navigation device mounted on the vehicle to generate a recommended path bypassing a gas station.

11. The method of claim 10, wherein notifying the display device in the vehicle includes:
based on the residual being less than a second ratio that is predetermined to be less than the first predetermined ratio compared to the entire amount, changing, by the processor, the reference weight value to a lower value and notifying the change of the reference weight value to the display device.

12. The method of claim 1, wherein the first local data includes:
a value calculated by multiplying basic weights for respective predetermined vehicle types by a predetermined weight.

13. A device for monitoring cargo weights implemented in a vehicle comprising:
a communication interface;
at least one non-transitory computer-readable medium configured to store instructions; and
at least one processor configured, by executing the instructions, to:
receive first remote data on whether to activate cargo weight monitoring from a remote server through the communication interface;
determine whether a value of the first remote data indicates an activation of cargo weight monitoring;
based on the value of the first remote data indicating the activation of cargo weight monitoring, receive second remote data on a reference weight value for determining whether to warn an overload from the remote server through the communication interface;
receive first local data on a body weight of the vehicle and second local data on a cargo bay weight of the vehicle through an internal network of the vehicle;
determine a total weight of the vehicle by using the first local data and the second local data;
compare the total weight and the second remote data, and
based on the total weight being greater than the second remote data, determine that the vehicle is overloaded.

14. The device of claim 13, wherein the at least one processor is further configured to:
based on the total weight being greater than the second remote data, set a flag on an overload weight state to be a first value during a loading or an unloading of the vehicle;
based on the total weight being not greater than the second remote data, set the flag to be a second value that is different from the first value during the loading or the unloading of the vehicle;
transmit the flag to the remote server through the communication interface; and
generate an overload warning notice through at least one of a buzzer installed in a cargo bay of the vehicle and a dashboard of the vehicle.

15. The device of claim 14, wherein the at least one processor is further configured to:
during a driving operation of the vehicle, receive the flag from the remote server; and
based a value of the flag being the first value, perform a stop inducing operation.

16. The device of claim 13, wherein the at least one processor is further configured to:
based on the total weight being not greater than the second remote data, transmit the total weight to a navigation device installed in the vehicle, and allow the navigation device to generate a recommended path bypassing a weight restricted road exceeding the total weight.

17. The device of claim 13, wherein the at least one processor is further configured to:
obtain a residual of a battery or fuel of the vehicle from an integrated vehicle controller;
based on the residual being less than a predetermined first ratio compared to an entire amount, notify a display device in the vehicle that the reference weight value is about to be changed; and
allow a navigation device mounted on the vehicle to generate a recommended path bypassing a gas station.

18. The device of claim 17, wherein the at least one processor is further configured to:
based on the residual being less than a second ratio that is predetermined to be less than the predetermined first ratio compared to the entire amount, change the reference weight value to a lower value and notify the change of the reference weight value to the display device.

19. The device of claim 13, wherein the first local data includes:
a value calculated by multiplying basic weights for respective predetermined vehicle types by a predetermined weight.

20. A non-transitory computer-readable medium configured to store instructions executable by a computing device,
wherein, when executed by at least one processor of the computing device, the instructions allow the computing device to:
receive first remote data on whether to activate cargo weight monitoring from a remote server through a communication interface;
determine whether a value of the first remote data indicates the activation of cargo weight monitoring;
based on the value of the first remote data indicating the activation of cargo weight monitoring, receive second remote data on a reference weight value for determining whether to warn an overload from the remote server through the communication interface;
receive first local data on a body weight of a vehicle and second local data on a cargo bay weight of the vehicle through an internal network of the vehicle;
determine a total weight of the vehicle by using the first local data and the second local data;
compare the total weight and the second remote data; and
based on the total weight being greater than the second remote data, determine that the vehicle is overloaded.
